(19) United States
(12) Patent Application Publication
(10) Pub. No.: US 2024/0420359 A1
(43) Pub. Date: Dec. 19, 2024

(54) PROFILE DETECTING METHOD AND PROFILE DETECTING APPARATUS

(71) Applicant: Tokyo Electron Limited, Tokyo (JP)

(72) Inventors: Toshihiro KITAO, Hokkaido (JP); Jun SHINAGAWA, Fremont, CA (US); Masato KAZUI, Hokkaido (JP); Makoto IGARASHI, Hokkaido (JP); Toshihiro OHNO, Hokkaido (JP)

(73) Assignee: Tokyo Electron Limited, Tokyo (JP)

(21) Appl. No.: 18/820,492

(22) Filed: Aug. 30, 2024

Related U.S. Application Data
(63) Continuation of application No. PCT/JP2022/012518, filed on Mar. 18, 2022.
(60) Provisional application No. 63/316,125, filed on Mar. 3, 2022.

(51) Int. Cl. G06T 7/62; G06T 7/00; G06T 7/50

(52) U.S. Cl. CPC G06T 7/62; G06T 7/0004; G06T 7/50; G06T 2207/10061; G06T 2207/30148

(57) ABSTRACT

The profile detecting method includes: detecting a specific shape included in a detection target image from the detection target image including the specific shape using a model that has learned a learning image including the specific shape and information regarding the specific shape included in the learning image; and outputting shape information of the detected specific shape.

### CROSS-REFERENCE TO RELATED APPLICATIONS

This application is a continuation of International Application No. PCT/JP2022/012518, filed on Mar. 18, 2022, which Claims benefit of U.S. provisional Patent Application No. 63/316,125, filed on Mar. 3, 2022, the entire contents of each are incorporated herein by reference.

### FIELD

The present disclosure relates to a profile detecting method and a profile detecting apparatus.

### BACKGROUND

Japanese Laid-open Patent Publication No. 2014-139537 discloses a technique for imaging a circuit pattern present at a desired position on a semiconductor device with a scanning electron microscope (SEM) in order to measure or inspect a semiconductor.

The present disclosure provides a technique for efficiently detecting a specific shape included in a detection target image.

### SUMMARY

According to an aspect of a present disclosure, a profile detecting method includes:

detecting a specific shape included in a detection target image from the detection target image including the specific shape using a model that has learned a learning image including the specific shape and information regarding the specific shape included in the learning image; and

outputting shape information of the detected specific shape, wherein

the detecting includes:

detecting a contour of the specific shape included in the detection target image from the detection target image,

detecting a border of a film included in the detection target image from the detection target image, and

detecting a region having the specific shape included in the detection target image from the detection target image;

at least one of the detecting the contour, the detecting the region, and the detecting the border performs detection using the model; and

the detecting the region specifies a range of the specific shape in one direction of the detection target image and an intersecting direction with respect to the one direction from the contour of the specific shape detected in the detecting the contour, and detects specified the range as a region of the specific shape.

### BRIEF DESCRIPTION OF DRAWINGS

FIG. 1 is a diagram illustrating an example of a functional configuration of an information processing apparatus according to an embodiment;

FIG. 2 is a diagram illustrating an example of an image of a cross-section of a substrate according to an embodiment;

FIG. 3 is a diagram illustrating an example of a binarized image according to an embodiment;

FIG. 4 is a diagram illustrating an example of a flow of generating a border detection model according to an embodiment;

FIG. 5 is a diagram illustrating an example of a flow of detecting a region of each recess of the image according to an embodiment;

FIG. 6 is a diagram illustrating an example of a flow of detecting a border of a film included in an image according to an embodiment;

FIG. 7 is a diagram illustrating an example of a detection result of a border of a film according to an embodiment;

FIG. 8 is a diagram schematically illustrating an example of a flow of a profile detecting method according to an embodiment; and

FIG. 9 is a diagram schematically illustrating another example of the flow of the profile detecting method according to an embodiment.

### DESCRIPTION OF EMBODIMENTS

Hereinafter, embodiments of a profile detecting method and a profile detecting apparatus disclosed in the present application will be described in detail with reference to the drawings. Note that the profile detecting method and the profile detecting apparatus disclosed in the present embodiment are not limited.

Conventionally, a process engineer supports optimization of a recipe of a semiconductor manufacturing process. For example, a cross-section of a semiconductor device in which a recess such as a trench or a hole is formed is imaged with a scanning electron microscope. Then, by measuring a dimension such as a critical dimension (CD) of the recess of the captured image, the appropriateness/inappropriateness of the recipe of the manufacturing process is judged. A process engineer manually designates a range of a recess of a captured image and designates a position of a contour for measuring a dimension, and measurement operation of the dimension is dependent on a human. As a result, it takes time to measure the dimension. In addition, since the measurement operation such as the designation of the position of the contour for measuring the dimension is human-dependent, a human-dependent error may occur in the measured dimension. In addition, it takes time and effort to measure dimensions of a large number of recesses.

Therefore, a technique for efficiently detecting a specific shape such as a recess included in an image is expected.

### EMBODIMENT

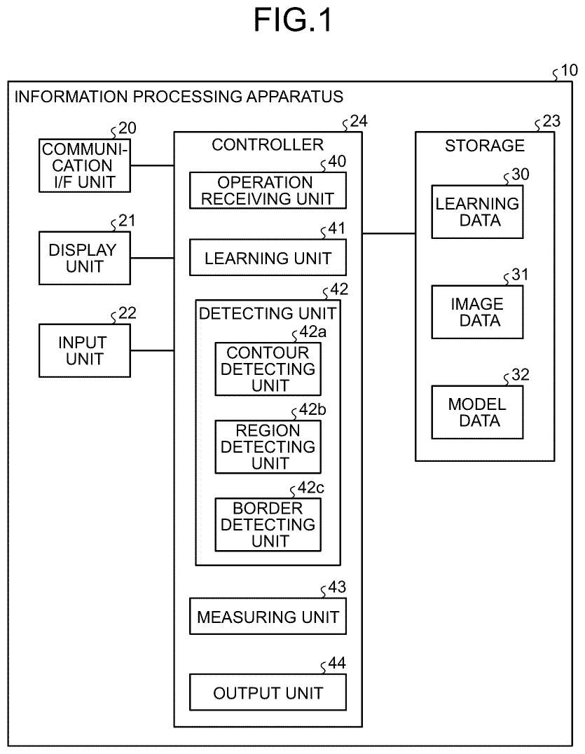

An embodiment will be described. Hereinafter, a case where a dimension of a specific shape such as a recess included in a captured image are measured by an information processing apparatus 10 will be described as an example. FIG. 1 is a diagram illustrating an example of a functional configuration of an information processing apparatus 10 according to an embodiment. The information processing apparatus 10 is an apparatus that provides a function of measuring a dimension of a specific shape included in a captured image. The information processing apparatus 10 is, for example, a computer such as a server computer or a personal computer. The process engineer measures the dimension of the recess of the captured image using the information processing apparatus 10. The information processing apparatus 10 corresponds to the profile detecting apparatus of the present disclosure.

The information processing apparatus 10 includes a communication interface (I/F) unit 20, a display unit 21, an input unit 22, a storage 23, and a controller 24. Note that the information processing apparatus 10 may include other devices included in the computer in addition to the above devices.

The communication I/F unit 20 is an interface that performs communication control with other apparatuses. The communication I/F unit 20 is connected to a network (not illustrated) and transmits and receives various types of information to and from other apparatuses via the network. For example, the communication I/F unit 20 receives data of a digital image captured by a scanning electron microscope.

The display unit 21 is a display device that displays various types of information. Examples of the display unit 21 include display devices such as a liquid crystal display (LCD) and a cathode ray tube (CRT). The display unit 21 displays various types of information.

The input unit 22 is an input device that inputs various types of information. Examples of the input unit 22 include input devices such as a mouse or a keyboard. The input unit 22 receives an operation input from a user such as a process engineer, and inputs operation information indicating the received operation content to the controller 24.

The storage 23 is a storage apparatus such as a hard disk, a solid state drive (SSD), or an optical disk. Note that the storage 23 may be a semiconductor memory capable of rewriting data, such as a random access memory (RAM), a flash memory, or a non-volatile static random access memory (NVSRAM).

The storage 23 stores various programs including an operating system (OS) executed by the controller 24 and a profile detecting program to be described later. Furthermore, the storage 23 stores various types of data used in the program executed by the controller 24. For example, the storage 23 stores learning data 30, image data 31, and model data 32.

The learning data 30 is data used to generate a model used to detect a profile. The learning data 30 includes various types of data used for generating a model. For example, the learning data 30 stores data of a learning image including a specific shape to be detected and information regarding the specific shape included in the learning image.

The image data 31 is data of a detection target image for detecting a profile.

The model data 32 is data that stores a model for detecting a specific shape. The model of the model data 32 is generated by performing machine learning of the learning data 30.

In the present embodiment, the learning image and the detection target image are images obtained by imaging a cross-section of the semiconductor device with a scanning electron microscope. The semiconductor device is formed on a substrate such as a semiconductor wafer, for example. The learning image and the detection target image are acquired by imaging a cross-section of the substrate on which the semiconductor device is formed with a scanning electron microscope. In the present embodiment, a recess such as a trench or a hole is detected as the specific shape from the detection target image.

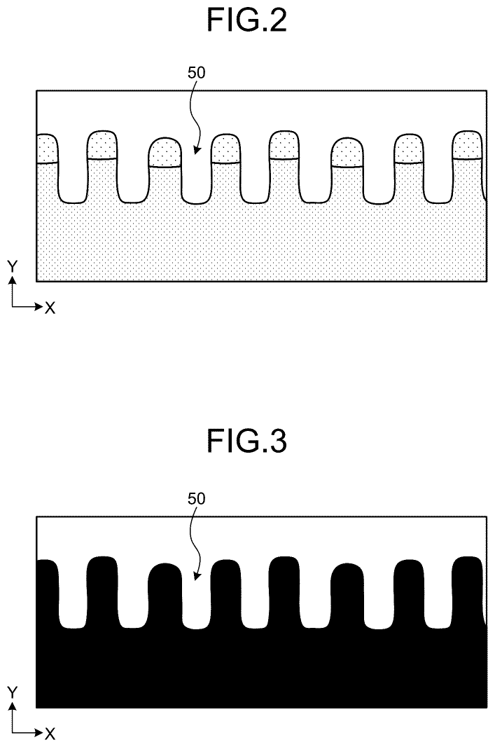

FIG. 2 is a diagram illustrating an example of an image of a cross-section of a substrate according to an embodiment. FIG. 2 is an image obtained by imaging a cross-section of a semiconductor device in which a trench or a hole is formed with a scanning electron microscope. The horizontal direction of the image is an x direction, and the vertical direction of the image is a y direction. In the image illustrated in FIG. 2, a plurality of recesses 50 recessed in the y direction is formed side by side in the x direction. The recess 50 is, for example, a cross-section of a trench or a hole formed in the semiconductor device.

The learning data 30 stores a plurality of sets of an image of a cross-section of the substrate used as the learning image and information regarding the recess 50 included in the image.

The image data 31 stores an image of a cross-section of a substrate as a profile detection target.

Returning to FIG. 1, the controller 24 is a device that controls the information processing apparatus 10. As the controller 24, an electronic circuit such as a central processing unit (CPU), a micro processing unit (MPU), or a graphics processing unit (GPU), or an integrated circuit such as an application specific integrated circuit (ASIC) or a field programmable gate array (FPGA) can be employed. The controller 24 includes an internal memory for storing programs defining various process sequences and control data, and executes various processes using the programs and the control data.

The controller 24 functions as various processing units by various programs operating. For example, the controller 24 includes an operation receiving unit 40, a learning unit 41, a detecting unit 42, a measuring unit 43, and an output unit 44.

The operation receiving unit 40 receives various operations. For example, the operation receiving unit 40 displays the operation screen on the display unit 21, and receives various operations on the operation screen from the input unit 22.

The information processing apparatus 10 can detect a profile by performing machine learning to generate the model data 32 and storing the model data 32 in the storage 23.

For example, the operation receiving unit 40 receives designation of the learning data 30 used for machine learning and an instruction to start model generation from the operation screen. In addition, for example, the operation receiving unit 40 receives designation of the image data 31 as a profile detection target from the operation screen. The operation receiving unit 40 reads the designated image data 31 from the storage 23, and displays an image of the read image data 31 on the display unit 21. The operation receiving unit 40 receives an instruction to start detection of a profile from the operation screen.

For example, the process engineer or the administrator designates the learning data 30 used for machine learning, and instructs the start of model generation. In addition, when judging the appropriateness/inappropriateness of the recipe, the process engineer designates, from the operation screen, the image data 31 of the cross-section of the semiconductor device on which the substrate processing of the recipe for which the appropriateness/inappropriateness is to be judged has been performed. Then, the process engineer gives an instruction on the start of profile detection from the operation screen.

The learning unit 41 performs machine learning on the designated learning data 30 and generates a model for detecting a specific shape included in an image. In the present embodiment, the learning unit 41 generates a model for detecting the recess 50 included in the image. The machine learning method may be any method as long as a model capable of detecting a specific shape can be obtained. Examples of the machine learning method include a method of performing image segmentation such as U-net.

The learning unit 41 generates a plurality of models used for detecting a specific shape included in an image. For example, the learning unit 41 generates a contour detection model that detects a contour of a specific shape included in an image. In addition, the learning unit 41 generates a border detection model that uses the border of the film included in an image for detection.

Here, a model generated by machine learning will be described. First, the contour detection model will be described. In the case of generating the contour detection model, the learning data 30 stores a plurality of pieces of data in which an image including the recess 50 illustrated in FIG. 2 is associated with information regarding the contour of the recess 50 included in the image. For example, a binarized image obtained by binarizing the image including the recess 50 is stored as the information regarding the contour of the recess 50.

FIG. 3 is a diagram illustrating an example of a binarized image according to an embodiment. FIG. 3 is a binarized image obtained by binarizing a portion of the film in which the substrate and the recess 50 are formed in the image of FIG. 2 as a first value (for example, 0) and a portion of the space as a second value (for example, 1). In FIG. 3, the portion of the first value of the binarized image is indicated by black, and the portion of the second value is indicated by white. For example, the learning data 30 stores a plurality of images including the recess 50 and binarized images of the images including the recess 50 in association with each other.

The learning unit 41 reads a plurality of pieces of data in which the image including the recess 50 stored in the learning data 30 is associated with the information regarding the contour of the recess 50 included in the image, and generates the contour detection model by machine learning. For example, the learning unit 41 generates the contour detection model by machine learning from a plurality of pieces of data in which the image including the recess 50 illustrated in FIG. 2 and the binarized image of the image including the recess 50 illustrated in FIG. 3 are associated with each other. The generated contour detection model inputs an image including the recess 50 and performs calculation to output information regarding the contour of the recess 50. For example, the contour detection model outputs a binarized image of the image including the recess 50.

First, the border detection model will be described. In the case of generating the border detection model, for each image including the recess 50 illustrated in FIG. 2, for each region of a predetermined size of the image, the learning data 30 stores data in which the image of the region and information on whether or not the image of the region includes the boundary of the film are associated with each other. For example, as the information on whether or not the boundary of the film is included, 1 is stored in a case where the border of the film is included, and 0 is stored in a case where the border of the film is not included.

The learning unit 41 reads data in which an image of a region obtained by dividing each image including the recess 50 stored in the learning data 30 for each predetermined size is associated with information on whether or not the image of the region includes a border of a film, and generates a border detection model by machine learning.

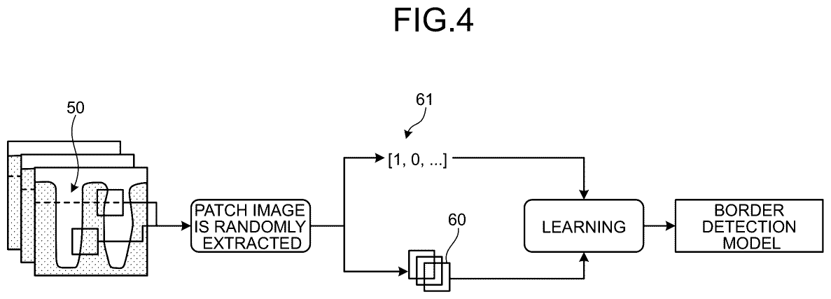

FIG. 4 is a diagram illustrating an example of a flow of generating a border detection model according to an embodiment. For example, for each image including the recess 50, an image of a region of a predetermined size of the image is randomly extracted, and data in which the image of the region and information on whether or not the image of the region includes a border of the film are associated with each other is created. In FIG. 4, an image of each region obtained by dividing each image including the recess 50 for each predetermined size is illustrated as a patch image 60. In addition, whether or not each patch image 60 includes a border of the film is illustrated as a label 61. The label 61 is stored as 1 in a case where the corresponding patch image 60 includes the border of the film, and as 0 in a case where the corresponding patch image does not include the border of the film. The learning data 30 stores data in which each patch image 60 is associated with information on whether or not the patch image 60 includes the border of the film.

The learning unit 41 reads the patch image 60 stored in the learning data 30 and the value of the label 61 corresponding to the patch image 60, and generates a border detection model by machine learning. The generated border detection model inputs an image of a predetermined size and performs calculation, outputting information on whether or not the image includes a border of a film. For example, the border detection model outputs 1 in a case where it is estimated that the border of the film is included, and outputs 0 in a case where it is estimated that the border of the film is not included.

The learning unit 41 stores the generated data of each model in the model data 32. For example, the learning unit 41 stores data of the generated contour detection model and border detection model in the model data 32.

When instruction on detection start of the profile is given, the detecting unit 42 detects the specific shape from the image of the designated image data 31 using the model stored in the model data 32. For example, the detecting unit 42 detects the recess 50 from the image of the designated image data 31 using the contour detection model and the border detection model stored in the model data 32.

The detecting unit 42 includes a contour detecting unit 42a, a region detecting unit 42b, and a border detecting unit 42c.

The contour detecting unit 42a detects the contour of the recess 50 included in the image of the designated image data 31 using the contour detection model stored in the model data 32. For example, the contour detecting unit 42a inputs an image of the designated image data 31 into the contour detection model and performs calculation. The contour detection model outputs a binarized image of the image of the input image data 31. For example, in a case where an image including the recess 50 illustrated in FIG. 2 is input, the contour detection model outputs a binarized image of the image including the recess 50 illustrated in FIG. 3. The contour detecting unit 42a detects the contour of the recess 50 from the binarized image output from the contour detection model. For example, the contour detecting unit 42a detects, as a contour, a border portion where pixel values change in adjacent pixels in the binarized image. For example, the contour detecting unit 42a generates an image in which the black region of the border portion is increased or decreased by one pixel from the binarized image. Then, the contour detecting unit 42a calculates, for each pixel at the corresponding position, a difference image obtained by obtaining a difference between the initial binarized image and an image in which the black region at the border portion is increased or decreased by one pixel. Since the border portion is increased or decreased by one pixel, only the boundary portion remains as a black region in the difference image. The contour detecting unit 42a detects a black region of the difference image as the contour of the recess 50.

The region detecting unit 42b detects the region of the recess 50 for each recess 50 in the image of the designated image data 31. For example, the region detecting unit 42b detects the region of the recess 50 for each recess 50 in the image using the detection result of the contour by the contour detecting unit 42a.

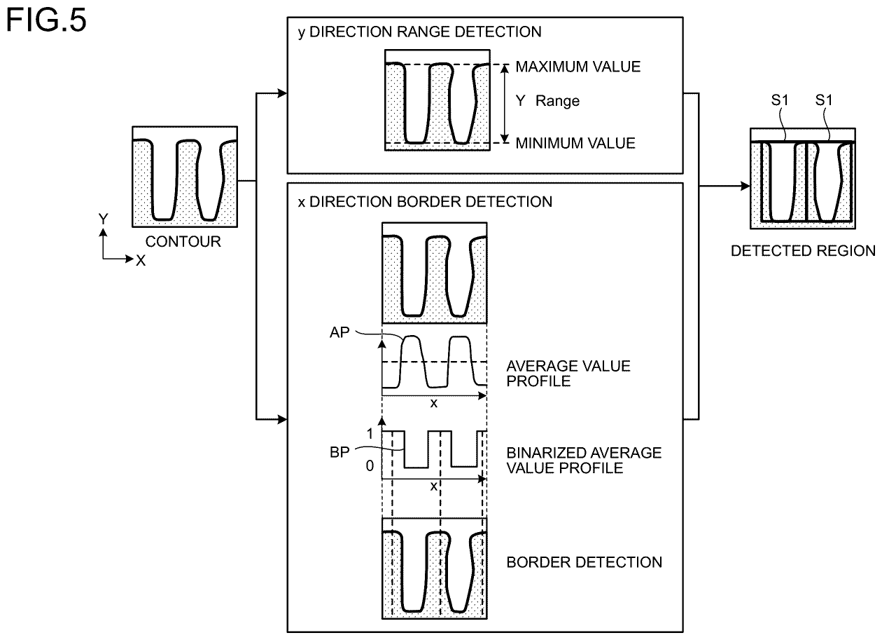

FIG. 5 is a diagram illustrating an example of a flow of detecting a region of each recess 50 of the image according to an embodiment. FIG. 5 illustrates an image in which the contour of the recess 50 is detected. The horizontal direction of the image is an x direction, and the vertical direction of the image is a y direction. For example, the region detecting unit 42b specifies a range in which the contour of the recess 50 detected by the contour detecting unit 42a exists in the y direction of the image. For example, the region detecting unit 42b obtains the minimum value and the maximum value with respect to the y direction from the coordinates of each pixel constituting the contour of the recess 50, and specifies the range of the minimum value and the maximum value as the range including the plurality of recesses 50 with respect to the y direction. In FIG. 5, a range including the recess 50 with respect to the y direction of the image is illustrated as Y Range.

The region detecting unit 42b detects the border of the region of each recess 50 in the x direction from the specified range of the image. For example, the region detecting unit 42b calculates an average value of the luminance of each pixel in the y direction for each position in the x direction of the image from the specified range of the image. The region detecting unit 42b detects the region of each recess 50 from the specified range of the image based on the calculated average value of respective position in the x direction.

For example, the region detecting unit 42b extracts the specified range of Y Range in the y direction of the image, and calculates the average value of the luminance of each pixel in the y direction for each position in the x direction of the image from the image of the extracted range of Y Range. The region detecting unit 42b arranges the average values of the respective positions in the x direction in order of the positions in the x direction to obtain a profile of the average value. FIG. 5 illustrates a profile AP of average values in which the average values of the respective positions in the x direction are arranged in order of the positions in the x direction. The region detecting unit 42b binarizes each value of the profile AP of the average value in the x direction. For example, the region detecting unit 42b obtains an average value of the profiles AP of the average value in the x direction, and binarizes each value of the profiles AP using the obtained average value as a threshold value. For example, the region detecting unit 42b binarizes each value of the profile AP as the first value in a case where the value of the profile AP as the average value is equal to or larger than the threshold value, and binarizes each value of the profile AP as the second value in a case where the value of the profile AP as the average value is smaller than the threshold value. FIG. 5 illustrates a binarized profile BP as “0” in a case where each value of the profile AP is equal to or larger than the threshold value (average value), and as “1” in a case where each value of the profile AP is smaller than the threshold value. The region detecting unit 42b detects the position of the center of the continuous portion as the pattern border of the recess 50 in the x direction for each continuous portion in which the second value is continuous in the binarized profile BP. For example, the region detecting unit 42b detects the position of the center of the continuous portion as the pattern border of the recess 50 in the x direction for each continuous portion in which “1” is continuous in the binarized profile BP. The region detecting unit 42b detects a region between the detected pattern borders as a region of the recess 50 for the image in the range of Y Range. In FIG. 5, a region of each recess 50 detected from the image in which the contour of the recess 50 is detected is indicated by a rectangle S1.

The border detecting unit 42c detects the border of the film included in the image of the designated image data 31 using the border detection model stored in the model data 32. For example, the border detecting unit 42c derives information on whether or not the image of each region includes the border of the film using the border detection model for each predetermined size used for generating the border detection model for the image of the designated image data 31. The border detecting unit 42c detects the border of the film included in the image of the designated image data 31 from the derived information for each region.

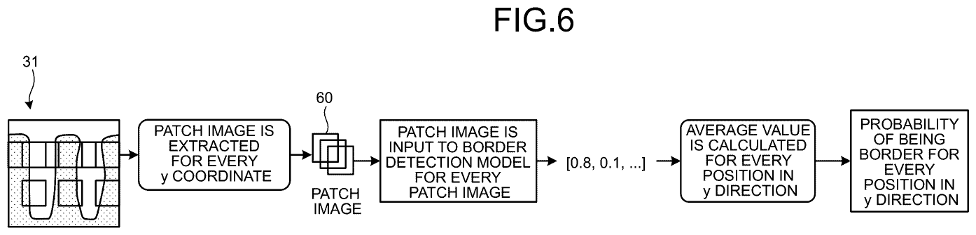

FIG. 6 is a diagram illustrating an example of a flow of detecting a border of a film included in an image according to an embodiment. FIG. 6 illustrates an image of the designated image data 31. For example, the border detecting unit 42c divides the image of the designated image data 31 into the patch images 60, and inputs the divided patch images 60 to the border detection model to perform the calculation. The border detection model outputs information on whether or not the input patch image 60 includes a border of the film. For example, the border detection model outputs 1 in a case where it is estimated that the border of the film is included, and outputs 0 in a case where it is estimated that the border of the film is not included. The border detecting unit 42c calculates, for each position in the y direction of the image of the image data 31, an average value of the output values of the border detection models of the patch images 60 at the same position in the y direction. The border detecting unit 42c arranges the average values of the respective positions in the y direction in order of the positions in the y direction to obtain a profile of the average value. The border detecting unit 42c detects the position of the border of the film based on the average value at each position in the y direction. The average value becomes close to 1 at the position including the border of the film, and becomes the probability of being the boundary. The border detecting unit 42c detects the position in the y direction where the average value is close to 1 as the position of the border of the film. For example, the border detecting unit 42c detects a position where the average value is equal to or larger than a predetermined threshold value (for example, 0.8) as the position of the border of the film.

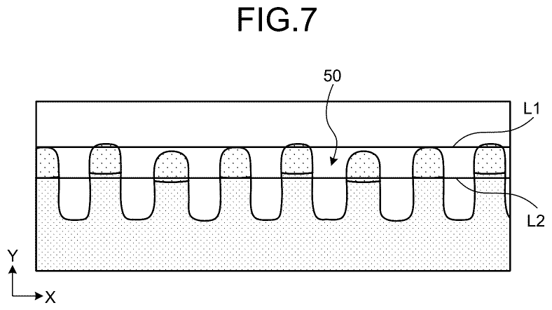

FIG. 7 is a diagram illustrating an example of a detection result of a border of a film according to an embodiment. FIG. 7 illustrates an example of an image of a cross-section of the substrate. In FIG. 7, the films constituting the side walls of the recess 50 are illustrated in different patterns, and the detected borders of the films in the y direction are indicated by lines L1 and L2. The film above the recess 50 in the image is, for example, a mask. The border detecting unit 42c can detect the border of the film. By detecting the border of the film in this manner, it can be used for automatic adjustment of the rotational deviation of the image. For example, the border detecting unit 42c may perform the rotation correction of the image in a manner that the line L2 becomes horizontal using the line L2 of the border of the film. As a result, the rotational deviation of the image can be corrected, and the positional relationship of the film, the film thickness, and the like can be easily grasped from the image.

Since the information processing apparatus 10 according to the embodiment can automatically detect the range of the recess 50 and the contour of the recess 50 of the image in this manner, it is possible to improve the efficiency of dimension measurement.

The measuring unit 43 measures dimensions. For example, the operation receiving unit 40 displays the image in which the contour of the recess 50 is detected by the contour detecting unit 42a on the display unit 21, and receives designation of the position of the contour of the recess 50 for measuring the dimension from the input unit 22. The measuring unit 43 measures the dimension of CD and the like of the recess 50 at the position of the designated contour.

Note that the measuring unit 43 may automatically measure the dimension such as CD of the recess 50 at a predetermined position of the contour without receiving the designation of the position. The position where the dimension is measured may be set in advance, or may be set based on the detection results of the border detecting unit 42c and the contour detecting unit 42a. For example, the measuring unit 43 may measure the dimension such as CD at the border of the film from the contour of each recess 50 detected by the contour detecting unit 42a at the position of the height of the border of the film detected by the border detecting unit 42c. In addition, for example, the measuring unit 43 may automatically measure the dimension such as CD at a predetermined position of the recess 50, such as the top portion (TOP) of each recess 50, the side wall central portion (MIDDLE) in the recess 50, and the bottom portion (BOTTOM) of the recess 50. In addition, the measuring unit 43 may measure the dimension of CD and the like at each position in the y direction from the edge profile of the contour of each recess 50 detected by the contour detecting unit 42a.

The output unit 44 outputs shape information of the specific shape detected by the detecting unit 42. For example, the output unit 44 displays the contour of the recess 50, the region of the recess 50, and the border of the film detected by the detecting unit 42 on the display unit 21 together with the image of the designated image data 31. In addition, the output unit 44 outputs a measurement result measured by the measuring unit 43 from the specific shape detected by the detecting unit 42. For example, the output unit 44 displays the measured dimension together with the measurement position on the display unit 21. The output unit 44 may store the shape information of the specific shape detected by the detecting unit 42 and the data of the measurement result in the storage 23, or may transmit the shape information and the data to another apparatus via the communication I/F unit 20.

Note that the output unit 44 may select a detection target region from a plurality of regions including a specific shape on the image to output only shape information that well represents a feature of interest. For example, the input unit 22 receives selection of a region of interest from a plurality of regions having specific shapes displayed on the display unit 21. For example, the input unit 22 receives selection of a region of the recess 50 of interest from the regions of the plurality of recesses 50 displayed on the display unit 21. The output unit 44 may output only the shape information of the selected region of the recess 50. For example, the output unit 44 may output only the feature amount of the recess 50 representing the feature of the recess 50 of interest, such as the dimension of such as CD of the selected recess 50. As a result, the process engineer can efficiently grasp the feature amount of the recess 50 of interest.

In addition, the output unit 44 may perform profile selection such as outlier removal and maximum CD selection on the measurement result measured by the measuring unit 43, and output the selected measurement result. For example, in the region of the recess 50, there may be a region inappropriate as a measurement target due to factors such as collapse of the side wall. By applying an outlier detection method such as a 30 rule to the TOP CD in the regions of all the measured recesses 50, it is possible to remove an abnormal value due to collapse of the side wall and the like. The output unit 44 may perform selection to remove an abnormal value by applying an outlier detection method such as a 30 rule to TOP CD in the regions of all the measured recesses 50, and output the selected measurement result. In addition, for example, there is a case where it is desired to select a recess having the largest CD as the recess 50 to be measured. The output unit 44 may output shape information or a measurement result of the recess 50 having the largest CD. For example, the output unit 44 may output the maximum value among TOP CD of the recess 50 not removed by the outlier detection. In addition, the output unit 44 may select based on not the maximum value but a median value or a score of an unsupervised learning model such as Local Outlier Factor. In addition, the output unit 44 may not only select and output the shape information or the measurement result of one recess 50, but also calculate and output an average value or a median value of the shape information or the measurement results of the plurality of recesses 50.

### Processing Flow

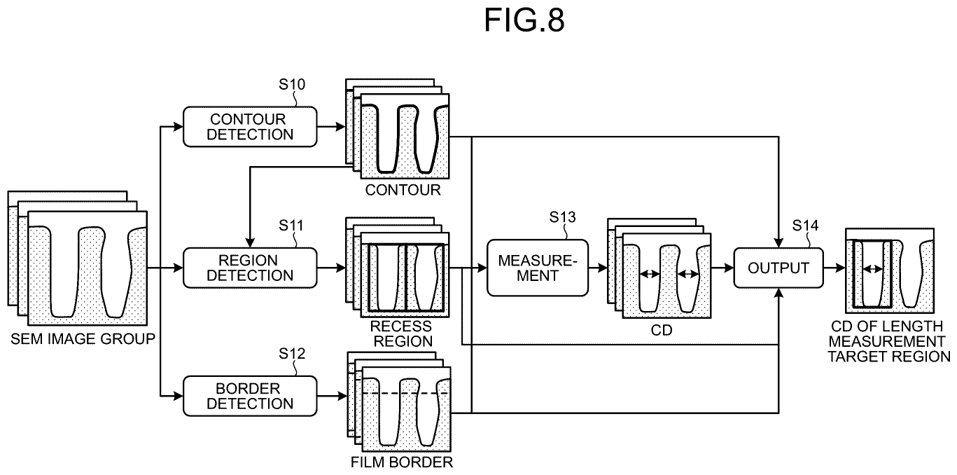

Next, a flow of the profile detecting method according to the embodiment will be described. The information processing apparatus 10 according to the embodiment executes the profile detecting program to implement the profile detecting method. FIG. 8 is a diagram schematically illustrating an example of a flow of a profile detecting method according to an embodiment.

When judging the appropriateness/inappropriateness of the recipe, the process engineer designates the image data 31 and gives an instruction on the start of profile detection.

When the detecting unit 42 designates the image data 31 and is instructed to start detection of a profile, the detecting unit 42 detects the specific shape from the image of the designated image data 31 using the model stored in the model data 32. For example, the contour detecting unit 42a detects the contour of the recess 50 included in the image of the designated image data 31 using the contour detection model stored in the model data 32 (Step S10). The region detecting unit 42b detects the region of the recess 50 for each recess 50 in the image using the detection result of the contour by the contour detecting unit 42a (Step S11). The border detecting unit 42c detects the border of the film included in the image of the designated image data 31 using the border detection model stored in the model data 32 (Step S12). Note that the processing in Steps S10 and S11 and the processing in Step S12 may be performed in reverse order or in parallel.

The measuring unit 43 measures dimensions (Step S13). For example, the measuring unit 43 measures a dimension such as CD of the recess 50 at a predetermined position of the contour.

The output unit 44 outputs shape information of the specific shape detected by the detecting unit 42 (Step S14). For example, the output unit 44 displays the contour of the recess 50, the region of the recess 50, and the border of the film detected by the detecting unit 42 on the display unit 21 together with the image of the designated image data 31. In addition, the output unit 44 outputs a measurement result of the measuring unit 43. Note that the output unit 44 may perform profile selection such as outlier removal and maximum CD selection on the measurement result measured by the measuring unit 43, and output the selected measurement result.

Since the information processing apparatus 10 according to the embodiment can measure the dimension of the recess 50 of the image in this manner, it is possible to improve the efficiency of dimension measurement. As a result, the time required for measuring the dimension can be shortened. In addition, since the information processing apparatus 10 can detect the contour that is the position at which the dimension is measured, it is possible to reduce the human-dependent error that occurs in the measured dimension. In addition, the information processing apparatus 10 can efficiently measure dimensions of a large number of recesses 50. For example, by automatically measuring the dimension of each recess 50 included in the image, many measurement values used for data analysis can be collected. In addition, it is possible to detect the abnormal recess 50 by automatically measuring the dimension of each recess 50 included in the image and analyzing the measured dimension of each recess 50.

Note that, in the above embodiment, the case where the region detecting unit 42b detects the region of the recess 50 using the detection result of the contour by the contour detecting unit 42a has been described as an example. However, the present invention is not limited to this. The region detecting unit 42b may detect the region of the recess 50 without using the detection result of the contour by the contour detecting unit 42a. For example, the learning unit 41 generates a region detection model by machine learning from a plurality of pieces of data in which an image including the recess 50 and an image indicating a region of the recess 50 are associated with each other, and stores the region detection model in the model data 32. The region detecting unit 42b may detect the region of the recess 50 using the region detection model stored in the model data 32.

In addition, the contour detection model described in the above embodiment is an example, and the present invention is not limited to this. The contour detection model may be any model as long as the contour can be detected. The learning unit 41 may generate the contour detection model by machine learning from a plurality of pieces of data in which the image including the recess 50 is associated with the binarized image obtained by binarizing the contour portion of the image including the recess 50. The contour detecting unit 42a may input the image of the designated image data 31 into the contour detection model to perform calculation, and detect the contour of the recess 50 from the binarized image output from the contour detection model. The border detection model and the region detection model are also examples, and the present invention is not limited to these. The border detection model may be any model as long as the contour can be detected. The region detection model may be any model as long as the region of the recess 50 can be detected.

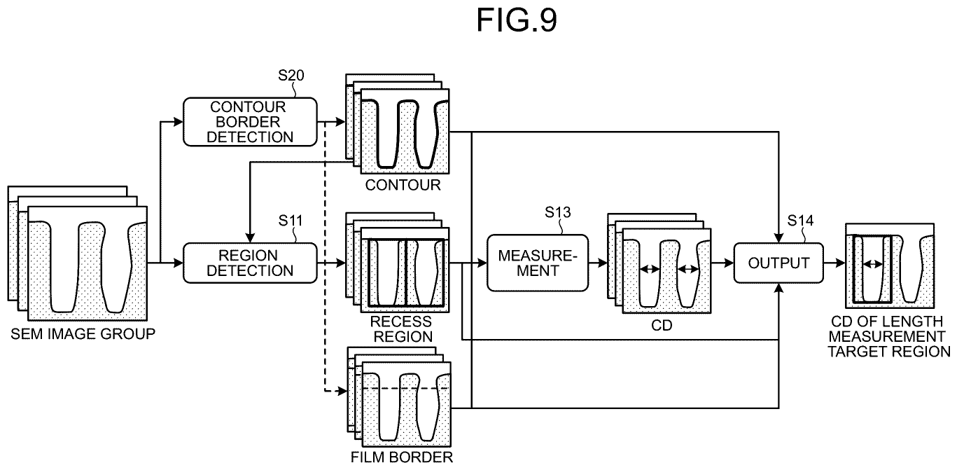

In addition, in the above embodiment, the case where the contour of the recess 50, the region of the recess 50, and the border of the film are individually detected has been described as an example. However, the present invention is not limited to this. Any two or all of the contour of the recess 50 and the border between the region of the recess 50 and the film may be detected using one model. For example, the border between the contour of the recess 50 and the film may be detected using one model. In this case, for example, the learning unit 41 may generate the contour border detection model by machine learning from a plurality of pieces of data in which the image including the recess 50 is associated with the binarized image obtained by binarizing the contour portion of the image including the recess 50 and the border portion of the film. The detecting unit 42 may input the designated image data 31 to the generated contour border detection model to perform calculation, and detect the contour of the recess 50 and the boundary of the film from the binarized image output from the contour border detection model. FIG. 9 is a diagram schematically illustrating another example of the flow of the profile detecting method according to an embodiment. FIG. 9 illustrates a case where the contour of the recess 50 and the border of the film are simultaneously detected. In FIG. 9, instead of Steps S10 and S12 in FIG. 8, the detecting unit 42 inputs designated image data 31 to the contour border detection model to perform calculation, and detects the contour of the recess 50 and the boundary of the film from the binarized image output from the contour border detection model (Step S20).

In addition, the images of the learning data 30 and the image data 31 may include an image out of focus. Therefore, the learning unit 41 may perform learning by removing an image that is out of focus. The detecting unit 42 may detect the specific shape by removing the image that is out of focus. For example, the learning unit 41 and the detecting unit 42 apply fast Fourier transform (FFT) to the entire image, and judge that the image is out of focus in a case where the magnitude of the power of the high frequency is equal to or less than a threshold value.

As described above, the profile detecting method according to the embodiment includes the detection process (Steps S10 to S12) and the output process (Step S14). The detection process detects a specific shape included in a detection target image from the detection target image including the specific shape using a model that has learned a learning image including the specific shape and information regarding the specific shape included in the learning image. The output process outputs shape information of the detected specific shape. As a result, the profile detecting method according to the embodiment can efficiently detect the specific shape included in the detection target image. Thus, the profile detecting method according to the embodiment can efficiently measure the dimension of the specific shape. For example, the profile detecting method according to the embodiment can efficiently detect the recess 50 included in the image, and can shorten the time required for measuring the dimension of the recess 50. In addition, the profile detecting method according to the embodiment can reduce human-dependent errors that occur in measured dimensions. In addition, the profile detecting method according to the embodiment can efficiently measure dimensions of a large number of recesses 50.

In addition, the detection process includes a contour detection process (Step S10), a border detection process (Step S12), and a region detection process (Step S11). The contour detection process detects a contour of the specific shape included in the detection target image from the detection target image. The border detection process detects a border of a film included in the detection target image from the detection target image. The region detection process detects a region having the specific shape included in the detection target image from the detection target image. At least one of the contour detection process, the region detection process, and the border detection process performs detection using the model. As a result, the profile detecting method according to the embodiment can efficiently measure the dimension of the specific shape from the detected contour of the specific shape, the border of the film, and the region of the specific shape.

In addition, the learning image and the detection target image are images of a cross-section of a semiconductor substrate in which a plurality of recesses 50 indicating a cross-section of a via or a trench is arranged as the specific shape. As a result, the profile detecting method according to the embodiment can efficiently detect the recess 50 included in the detection target image. Thus, the profile detecting method according to the embodiment can efficiently measure the dimension of the recess 50.

In addition, the profile detecting method according to the embodiment further includes a measurement process (Step S13). In the measurement process, the dimension of the detected specific shape is measured. As a result, the profile detecting method according to the embodiment can efficiently measure the dimension of the specific shape.

In addition, the model learns the learning image and information regarding the contour of the specific shape included in the learning image. Using the model, the contour detection process detects a contour of the specific shape included in the detection target image from the detection target image. As a result, the profile detecting method according to the embodiment can accurately detect the contour of the specific shape.

In addition, the model learns, for each region of a predetermined size of the learning image, an image of the region and information on whether or not an image of the region includes a border of a film. In the border detection process, for each region of the predetermined size of the detection target image, information on whether or not the image of each region includes a border of a film is derived using the model, and the border of the film included in the detection target image is detected from the derived information for each region. As a result, the profile detecting method according to the embodiment can accurately detect the border of the film.

In addition, in the region detection process, a range of the specific shape is specified in one direction of the detection target image and an intersecting direction with respect to the one direction from the contour of the specific shape detected in the contour detection process, and the specified range is detected as a region of the specific shape. As a result, the profile detecting method according to the embodiment can accurately detect the region of the specific shape.

In addition, in the output process, a detection target region is selected from a plurality of regions including a specific shape on the image to output only shape information that well represents a feature of interest. As a result, the profile detecting method according to the embodiment can output only the shape information indicating the feature of interest by selecting the detection target region.

In addition, the output process selects a detection target region from a plurality of regions including the shape of the recess 50 on the image to output only a feature amount of the recess 50 that well represents a feature of interest. As a result, the profile detecting method according to the embodiment can output only the feature amount of the recess 50 indicating the feature of interest by selecting the detection target region.

Although the embodiment has been described above, it should be considered that the embodiment disclosed herein is illustrative in all respects and is not restrictive. Indeed, the embodiments described above may be embodied in a variety of forms. In addition, the above-described embodiments may be omitted, replaced, or modified in various forms without departing from the scope and spirit of the claims.

For example, in the above embodiment, the case where the contour detection (Step S10), the region detection (Step S11), and the border detection (Step S12) are sequentially performed has been described as an example. However, the present invention is not limited to this. The order of contour detection, region detection, and border detection may be different. For example, the border detection, the contour detection, and the region detection may be performed in this order.

In addition, in the above embodiment, the case of measuring the dimension of the recess of the semiconductor device formed on the substrate such as the semiconductor wafer has been described as an example. However, the present invention is not limited to this. The substrate may be any substrate such as a glass substrate. The profile detecting method according to the embodiment may be applied to the measurement of the dimension of the recess of any substrate. For example, the profile detecting method according to the embodiment may be applied to the measurement of the dimension of the recess formed in the substrate for FPD.

According to the present disclosure, a specific shape included in a detection target image can be efficiently detected.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A profile detecting method comprising:
detecting a specific shape included in a detection target image from the detection target image including the specific shape using a model that has learned a learning image including the specific shape and information regarding the specific shape included in the learning image; and
outputting shape information of the detected specific shape, wherein
the detecting includes:
detecting a contour of the specific shape included in the detection target image from the detection target image,
detecting a border of a film included in the detection target image from the detection target image, and
detecting a region having the specific shape included in the detection target image from the detection target image;
at least one of the detecting the contour, the detecting the region, and the detecting the border performs detection using the model; and
the detecting the region specifies a range of the specific shape in one direction of the detection target image and an intersecting direction with respect to the one direction from the contour of the specific shape detected in the detecting the contour, and detects specified the range as a region of the specific shape.

2. The profile detecting method according to claim 1, wherein
the learning image and the detection target image are images of a cross-section of a semiconductor substrate in which a plurality of recesses indicating a cross-section of a via or a trench is arranged as the specific shape.

3. The profile detecting method according to claim 1, further comprising:
measuring a dimension of the detected specific shape, wherein
the outputting outputs the measured dimension.

4. The profile detecting method according to claim 1, wherein
the model learns information regarding the learning image and a contour of the specific shape included in the learning image, and
the detecting the contour detects the contour of the specific shape included in the detection target image from the detection target image using the model.

5. The profile detecting method according to claim 1, wherein
the model learns, for each region of a predetermined size of the learning image, an image of the region and information on whether or not an image of the region includes a border of a film, and
the detecting the border derives information on whether or not the image of each region includes a border of a film using the model, for each region of the predetermined size of the detection target image, and detects the border of the film included in the detection target image from derived the information.

6. The profile detecting method according to claim 1, wherein
the outputting selects a detection target region from a plurality of regions including the specific shape on an image to output only shape information indicating a feature of interest.

7. The profile detecting method according to claim 1, wherein
the outputting selects a detection target region from a plurality of regions including a recess on an image, and outputs only a recess feature amount indicating a feature of interest.

8. A profile detecting apparatus comprising:
a detecting unit that detects a specific shape included in a detection target image from the detection target image including the specific shape using a model that has learned a learning image including the specific shape and information regarding the specific shape included in the learning image; and
an output unit that outputs shape information of the specific shape detected by the detecting unit, wherein
the detecting unit includes:
a contour detecting unit that detects a contour of the specific shape included in the detection target image from the detection target image,
a border detecting unit that detects a border of a film included in the detection target image from the detection target image, and
a region detecting unit that detects a region having the specific shape included in the detection target image from the detection target image;
at least one of the contour detecting unit, the region detecting unit, and the border detecting unit detects using the model; and
the region detecting unit specifies a range of the specific shape in one direction of the detection target image and an intersecting direction with respect to the one direction from the contour of the specific shape detected in the contour detecting unit, and detects specified the range as a region of the specific shape.
